(19) United States
(12) Patent Application Publication
(10) Pub. No.: US 2008/0158602 A1
(43) Pub. Date: Jul. 3, 2008

(54) DATA PROCESSING APPARATUS

(76) Inventor: Yasuhiro NAKAI, Souraku-gun (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 11/959,531

(22) Filed: Dec. 19, 2007

(30) Foreign Application Priority Data
Dec. 28, 2006 (JP) 2006-354741
Dec. 28, 2006 (JP) 2006-354751

(51) Int. Cl. G06F 15/00

(52) U.S. Cl. 358/1.16

(57) ABSTRACT

A data processing apparatus is provided that includes an interface capable of mechanically restricting a memory card from being attached/detached in conjunction with instructions for the timing of attaching/detaching the memory card. The apparatus includes a memory card attaching portion, an operation instructing portion that gives instructions related to the memory card and accepts user operations, and a cover portion that covers the memory card attaching portion. The cover portion is in the opened state, a memory card can be attached/detached to/from the memory card attaching portion and the input operation can be performed from the operation instructing portion, and when a memory attachment detecting portion detects that the memory is attached and the cover portion is put into the closed state, the data processing portion executes a data process in accordance with the input operation.

### CROSS-NOTING PARAGRAPH

This Non-provisional application claims priority under 35 U.S.C. §119 (a) on Patent Applications No. 2006-354741 filed in JAPAN on Dec. 28, 2006 and No. 2006-354751 filed in JAPAN on Dec. 28, 2006, the entire contents of which are hereby incorporated herein by references.

### FIELD OF THE INVENTION

The present invention relates to a data processing apparatus that executes a predetermined process for data related to a portable recording medium.

### BACKGROUND OF THE INVENTION

Recently, opportunities to use a portable recording medium (hereinafter, a memory or a memory card) are increased. For example, the opportunities include such a case that image data taken by a digital camera, etc., are recorded in a memory card to print (to execute a print process of) the image data with the use of a data processing apparatus disposed in a store such as a convenience store. In this case, after mounting a memory card on the data processing apparatus, a user displays the recorded data such as images in the memory card on a displaying device disposed on the data processing apparatus to select image data to be printed.

If the data recorded in the memory card are printed using the data processing apparatus as above, the displaying device must sequentially display operation information (guidance screen) such as an instruction for the timing of attaching/detaching the memory card, an instruction for selecting data, and an instruction for printing to enhance the operationality for the user.

However, after mounting the memory card on the data processing apparatus, if a user takes out the memory card while the data in the memory card are transferred to the data processing apparatus (during data access), the memory card and the data recorded therein may be destroyed. Therefore, a memory card protecting apparatus is proposed that can protect data even if the memory card is taken out during data access (see, e.g., Japanese Laid-Open Patent Publication No. 2000-113663).

On the other hand, if the data recorded in the memory card are printed, the displaying device must sequentially display the operation information (guidance screen) such as an instruction for the timing of attaching/detaching the memory card, an instruction for selecting data, and an instruction for printing to enhance the operationality for the user. In some examples of the displaying device of the data processing apparatus used in this form, for example, in a displaying device of a multi-function peripheral (image forming apparatus) described in Japanese Laid-Open Patent Publication No. 2000-132010, a large-sized displaying device is separately disposed near the multi-function peripheral, and the image data and the guidance information are displayed on the large-sized displaying device to enhance the operationality.

If the technology disclosed in Japanese Laid-Open Patent Publication No. 2000-113663 is utilized, data can be prevented from being destroyed due to taking out a memory card during data access. However, since the manufacturing costs of the data processing apparatus are increased if the apparatus is disposed on the data processing apparatus (multi-function peripheral), the apparatus cannot be disposed on the data processing apparatus with the aim of merely preventing the data from being destroyed. The data can only be protected even if the memory card is taken out during data access, and the attaching/detaching of the memory card is not mechanically restricted in conjunction with a series of user operations.

If the print process is executed, various pieces of operation information must sequentially be displayed other than the instruction for the timing of attaching/detaching the memory card. If the operation information is merely displayed, the memory card can be taken out by mistake during the data access and the recorded data can be destroyed even when the instruction information is displayed for the timing of attaching/detaching the memory card since users utilizing the data processing apparatus, especially in convenience stores etc., often are unfamiliar with the operation. Therefore, in the case of a multi-function data processing apparatus where the memory card can be attached and utilized, since the memory card must be prevented from being attached/detached by mistake while giving the instructions such that the user operations are correctly performed for various functions utilized by users, it is not sufficient to only display the guidance information on the large-sized displaying device as disclosed in Japanese Laid-Open Patent Publication No. 2000-132010.

Especially when the print process, etc., are executed by the data processing apparatus, a user must perform various operations and the guidance screen must be displayed in conjunction with a series of operations performed by the user such that the operations can correctly be performed to enhance the convenience of the user. That is, the attaching/detaching of the memory card must mechanically be restricted during data access in conjunction with the instructions for the timing of attaching/detaching the memory card.

After the print process is completed, the memory card attached by a user may be forgotten to be taken out. If the memory card having user-specific information (image data) recorded thereon is forgotten to be taken out, the user-specific information such as personal information could be leaked. Therefore, an instruction must be given to a user so as not to forget to take out the attached memory card after the print process is completed.

### SUMMARY OF THE INVENTION

It is the object of the present invention to enable a multi-function data processing apparatus utilizing a portable recording medium (e.g., memory card) to give an instruction for the timing of attaching/detaching the memory card and mechanically restrict a memory from being attached/detached in conjunction with a series of user operations and to display a guidance screen in conjunction with a series of user operations to enhance the convenience of the user.

A first technical means is a data processing apparatus comprising: a recording medium attaching portion that can have a recording medium detachably attached; an attachment detecting portion that detects whether a recording medium is attached to the recording medium attaching portion; an operation instructing portion that gives instructions to prompt operations for a data process related to the recording medium and accepts user operations; a data processing portion that executes a data process in accordance with the input operation from the operation instructing portion; and a cover portion that is freely opened and closed to cover the recording medium attaching portion, only when the cover portion is in the opened state, the data processing apparatus allowing a recording medium to be attached/detached to/from the recording medium attaching portion and the input operation from the operation instructing portion, when the attachment detecting portion detects that the recording medium is attached and the cover portion is put into the closed state, the data processing portion executing a data process in accordance with the input operation.

A second technical means is the data processing apparatus as defined in the first technical means, wherein the cover portion covers the recording medium attaching portion and the operation instructing portion.

A third technical means is the data processing apparatus as defined in the first technical means, comprising a guide displaying portion that displays operation guide information of the data processing apparatus on the upper side of the cover portion or in the vicinity of the cover portion.

A fourth technical means is the data processing apparatus as defined in the third technical means, comprising a locking device that holds the cover portion in the closed state, wherein the guide displaying portion displays the operation guide information prompting the locking device to be operated.

A fifth technical means is the data processing apparatus as defined in the third technical means, wherein the guide displaying portion displays the status of the data process of the data processing apparatus.

A sixth technical means is the data processing apparatus as defined in the third technical means, wherein the guide displaying portion displays the operation guide information related to opening of the cover portion, taking out of the recording medium, etc., in conjunction with the completion of the data process of the data processing apparatus.

A seventh technical means is the data processing apparatus as defined in the third technical means, wherein the guide displaying portion displays information indicating whether the recording medium is attached to the recording medium attaching portion.

An eighth technical means is a data processing apparatus comprising: a first operation instructing portion that includes an operating portion accepting user operations for a data process related to input data of a first data input portion; a second operation instructing portion that gives instructions to prompt operations for a data process related to input data of a second data input portion and accepts user operations; a data processing portion that executes a data process in accordance with the input operation from the first operation instructing portion or the second operation instructing portion; and a cover portion that is freely opened and closed to cover the second data input portion, the first operation instructing portion being disposed on the upper surface of the cover portion, only when the cover portion is in the opened state, the data processing apparatus allowing the input operation from the second operation instructing portion.

A ninth technical means is the data processing apparatus as defined in the eighth technical means, wherein the second data input portion is a recording medium attaching/detaching portion and wherein only when the cover portion is in the opened state, a recording medium can be attached/detached to/from the recording medium attaching/detaching portion.

A tenth technical means is the data processing apparatus as defined in the eighth technical means, wherein the cover portion covers the second data input portion and the second operation instructing portion.

An eleventh technical means is the data processing apparatus as defined in the eighth technical means, wherein the first data input portion do not operate when the cover portion is in the opened state.

A twelfth technical means is the data processing apparatus as defined in the eighth technical means, wherein when the cover portion is in the closed state, if the input operation from the first operation instructing portion is performed and data are input from the first data input portion, the data processing portion executes a data process corresponding to the input operation from the first operation instructing portion.

A thirteenth technical means is the data processing apparatus as defined in the eighth technical means, wherein when the cover portion is in the opened state, if the input operation from the second operation instructing portion is performed and the cover portion is closed, the data processing portion executes a data process corresponding to the input operation from the second operation instructing portion.

A fourteenth technical means is the data processing apparatus as defined in the eighth technical means, comprising a guide displaying portion that displays operation guide information, wherein the guide displaying portion displays a selection screen for selecting a data process using either the first data input portion or the second data input portion.

A fifteenth technical means is the data processing apparatus as defined in the fourteenth technical means, wherein if the cover portion is opened while the guide displaying portion displays the selection screen, the second data input portion is made operable as a selection is made to operate the second data input portion.

A sixteenth technical means is the data processing apparatus as defined in the eighth technical means, wherein the second data input portion also is a data output portion.

### BRIEF DESCRIPTION OF THE DRAWINGS

FIG. 1 depicts an exterior view of a data processing apparatus (multi-function peripheral);

FIG. 2A is an enlarged view of an example of a usage state of a second displaying device;

FIG. 2B depicts another usage state of the second displaying device;

FIG. 2C depicts another usage state of the second displaying device;

FIG. 2D depicts another usage state of the second displaying device;

FIG. 2E depicts another usage state of the second displaying device;

FIG. 2F depicts another usage state of the second displaying device;

FIG. 2G depicts another usage state of the second displaying device;

FIG. 2H depicts another usage state of the second displaying device;

FIG. 3 is a block diagram of the data processing apparatus (multi-function peripheral);

FIG. 4A is a flowchart for selecting functions of the data processing apparatus;

FIG. 4B is a flowchart for explaining the print process of the data processing apparatus;

FIG. 4C is a flowchart for explaining the memory download process of the data processing apparatus;

FIG. 4D is a flowchart for explaining the scan memory copy process of the data processing apparatus;

FIG. 4E is a flowchart for explaining the copy process of the data processing apparatus;

FIG. 5A depicts an example of a guidance screen;

FIG. 5B depicts another example of the guidance screen;

FIG. 5C depicts another example of the guidance screen;

FIG. 5D depicts another example of the guidance screen;

FIG. 5E depicts another example of the guidance screen;

FIG. 5F depicts another example of the guidance screen;

FIG. 5G depicts another example of the guidance screen;

FIG. 5H depicts another example of the guidance screen;

FIG. 5I depicts another example of the guidance screen;

FIG. 5J depicts another example of the guidance screen;

FIG. 5K depicts another example of the guidance screen;

FIG. 5L depicts another example of the guidance screen;

FIG. 5M depicts another example of the guidance screen;

FIG. 5N depicts another example of the guidance screen;

FIG. 5O depicts another example of the guidance screen;

FIG. 5P depicts another example of the guidance screen;

FIG. 5Q depicts another example of the guidance screen;

FIG. 5R depicts another example of the guidance screen; and

FIG. 5S depicts another example of the guidance screen.

### PREFERRED EMBODIMENTS OF THE INVENTION

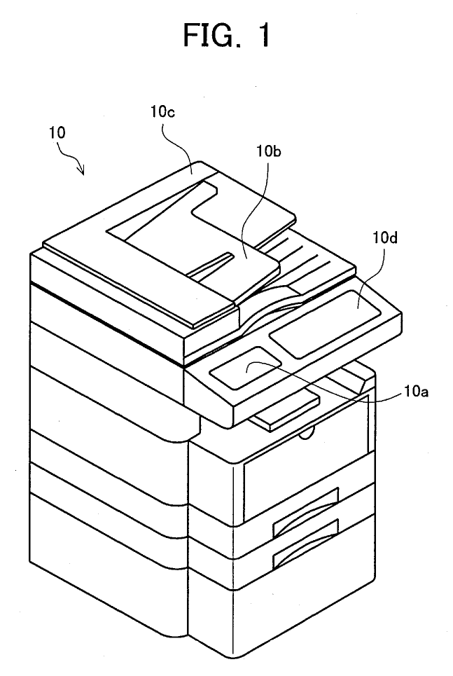

FIG. 1 depicts an exterior view of a multi-function data processing apparatus where a portable recording medium such as a memory card can be attached and utilized, for example, a multi-function peripheral 10 disposed in convenience stores, etc., and the multi-function peripheral (multi-functional composite machine) 10 includes at least two or more functions of a document reading function (scan function), a function of printing the read documents (copy function), a function of printing data recorded in a memory card (print function), a memory download function of recording data transferred to the multi-function peripheral 10 onto a memory card, a scan memory copy function of copying the read (scan) document data onto a memory card, a facsimile function, and an e-mail transmission/reception function.

In FIG. 1, 10a denotes a first displaying device that displays guidance (operation guide) information referenced when operating the multi-function peripheral 10, for example, state information indicating a state of the multi-function peripheral 10 such as paper jam; 10b denotes an automatic document feeding apparatus that feeds documents to the multi-function peripheral 10; 10c denotes a document holder opened and closed when setting a document on the multi-function peripheral 10; and 10d denotes a second displaying device that displays operation information, etc., of the data processing apparatus according to the present invention.

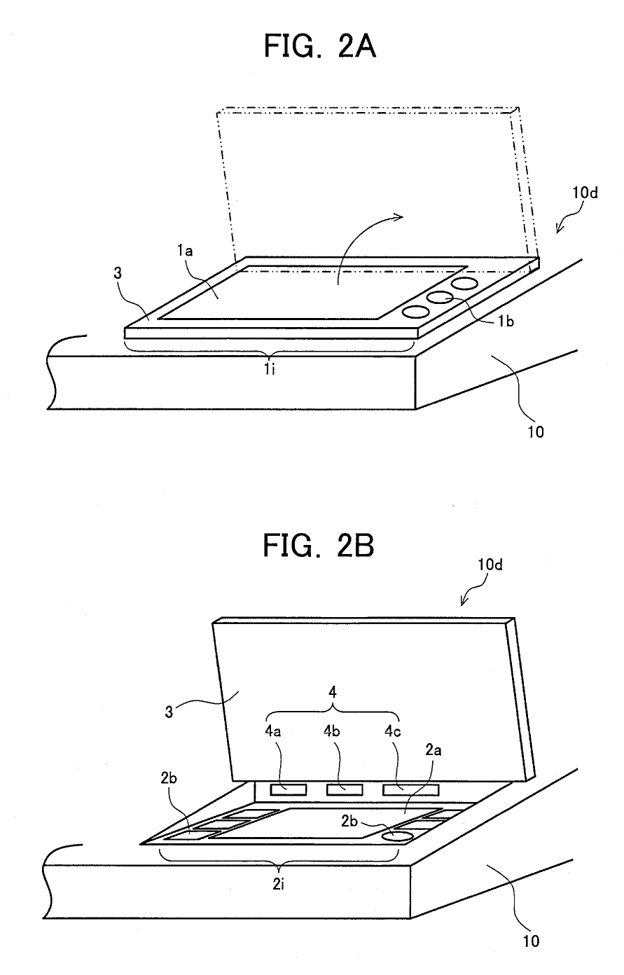

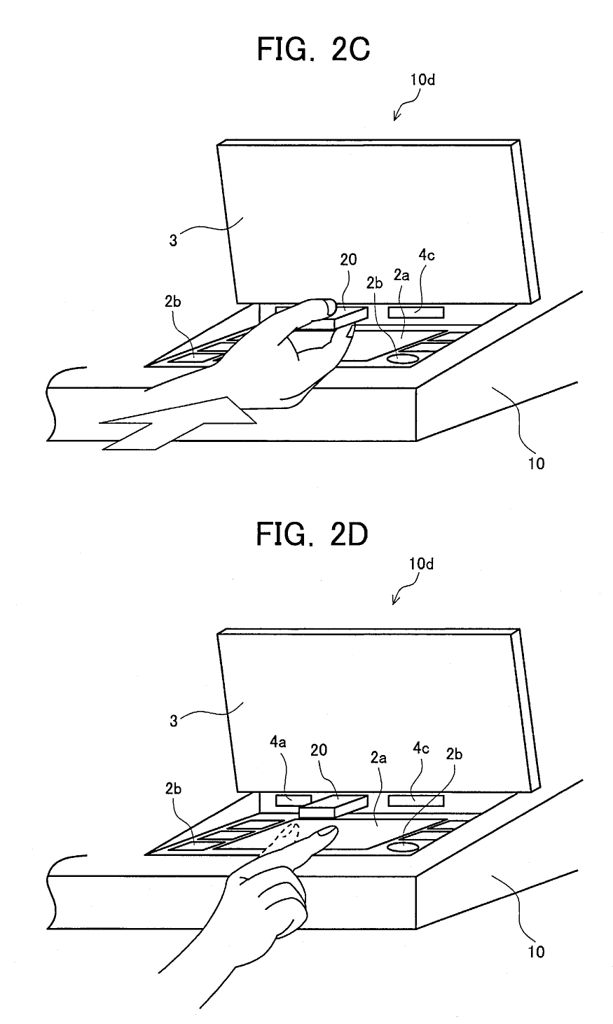

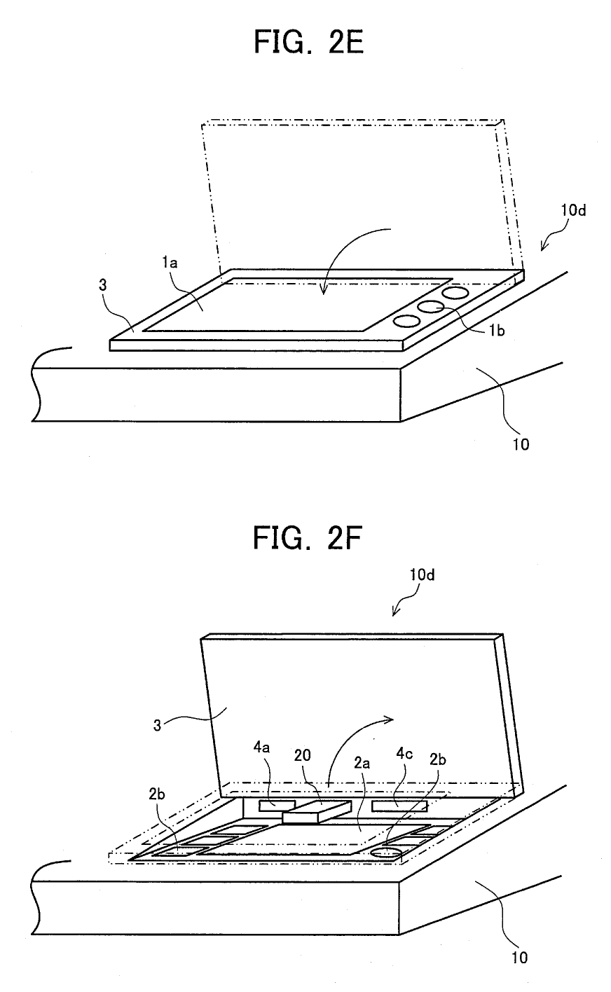

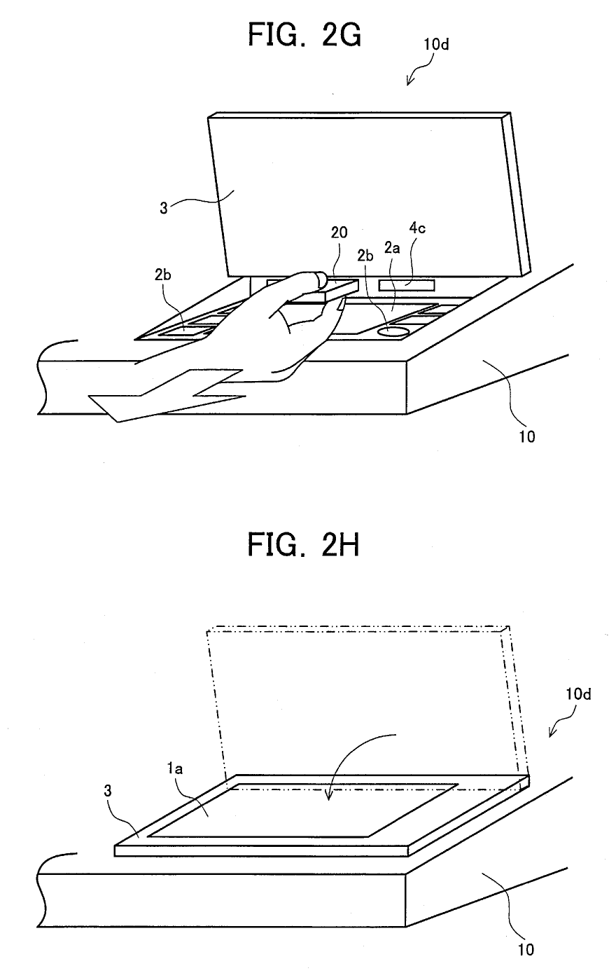

FIG. 2A shows an enlarged view of the second displaying device 10d. The second displaying device 10d has a cover portion 3 openable/closable with a hinge mechanism not shown, and the upper surface of the cover portion 3 is provided with a first operation instructing portion 1i including a guide displaying portion 1a that displays operation guide information of the data processing apparatus (multi-function peripheral) according to the present invention and an operating portion 1b that accepts operations for data processes related to data input from a data input portion such as a scanner. However, in some implementations described later, only the cover portion 3 is necessary, and the guide displaying portion 1a and the operating portion 1b are unnecessary.

FIG. 2B depicts a state when the cover portion 3 is opened, and opening the cover portion 3 reveals a second operation instructing portion 2i that forms an operation panel including a second display panel 2a and second operation keys 2b, and memory card attaching portions 4a to 4c that makes up a second data input portion 4. The second operation keys 2b are keys that input various operation instructions for data processes, and the display panel 2a displays operation information of instructions (operation instructions) for input operations of the data processes and the timing of attaching/detaching a recording medium, instructions for selecting data such as images to be printed. That is, the display panel 2a of the second operation instructing portion 2i performs the display (operation instruction) of the operation information prompting operations for the data processes related to the input data of the second data input portion 4 (memory card), and the second operation keys 2b accept user operations. The second data input portion 4 also is a data output portion that outputs and records data processed by the data processing apparatus onto a recording medium.

The second operation instructing portion 2i gives instructions for prompting user operations and accepts the user operations related to the processes for data recorded in the memory card or data to be recorded in the memory card. A user can give an instruction to execute the data process of the print function, the scan memory copy function, the memory download function, the copy function, etc., through the second operation instructing portion 2i as described later.

4a to 4c denote the attaching portions for attaching memories such as the MS (Memory Stick: registered trademark), the SD (Secure Digital Memory Card: registered trademark), and the CF (Compact Flash: registered trademark), respectively.

As apparent from FIG. 2B, only when the cover portion 3 is in the opened state, the memory cards can be attached to and detached from the memory card attaching portions 4a to 4c and the input operations can be performed through the operation instructing portion 2i.

Since the display panel 2a is disposed directly below the guide displaying portion 1a, a user can see the display panel 2a without significantly moving the eye when opening the cover portion 3, which enhances the visibility and the operationality for the user.

The guide displaying portion 1a may be disposed not only on the upper surface of the cover portion 3 but also in the vicinity of the cover portion 3. The first displaying device 10a may display the guide information. Although the cover portion 3 is disposed to cover the memory card attaching portions 4a to 4c and the second operation instructing portion 2i as shown, the cover portion 3 may be disposed to cover only the memory card attaching portions. The power consumption is reduced (electric power is saved) if the guide displaying portion 1a is operated only when the cover portion 3 is in the closed state.

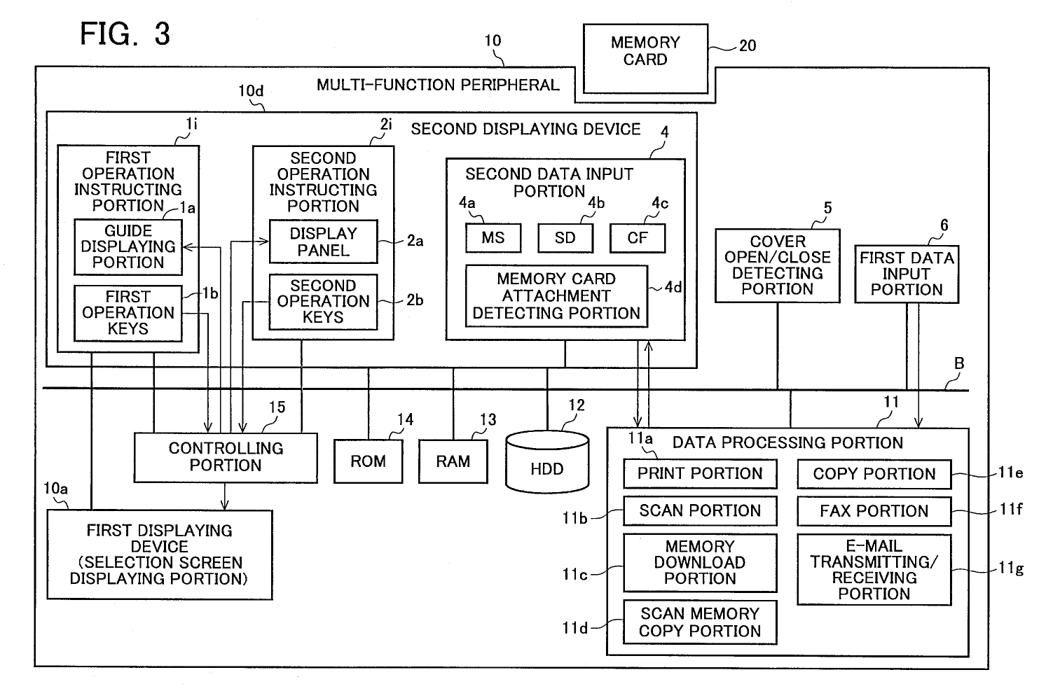

FIG. 3 is a block configuration view for explaining various functions of the multi-function peripheral 10 and the first displaying device 10a is made up of a liquid crystal panel. The second displaying device 10d comprises the first guide displaying portion 1a made up of a liquid crystal panel disposed on the top surface of the cover portion 3, the first operation instructing portion 1i comprising the first operation keys 1b, the second display panel 2a made up of a liquid crystal panel disposed on the underside of the cover portion 3, and the second operation instructing portion 2i comprising the second operation keys 2b made up of arrow keys, etc.

A data processing portion 11 is made up of a print portion 11a that executes a print process of data recorded in a memory card 20 in accordance with the input operation from the second operation instructing portion 2i, a scan portion 11b that executes a process of reading (scanning) a document for conversion into electronic data, a memory download portion 11c that executes a process of downloading onto the memory card 20 the data transferred to the multi-function peripheral 10 through the internet, etc., a scan memory copy portion 11d that executes a process of recording onto the memory card 20 the electronic data (scan data) converted by the scan portion 11b, a copy portion 11e that prints the data scanned by the scan portion 11b, a facsimile portion 11f that executes a so-called facsimile process, an e-mail transmitting/receiving portion 11g that executes the e-mail transmission/reception process, etc.

After data are input from the second operation instructing portion 2i while the cover portion 3 is opened, a memory card attachment detecting portion 4d detects that the memory card 20 is attached, and when a user closes the cover portion 3 (the cover portion 3 is in the closed state), the data processing portion 11 executes the data process in accordance with the input operation from the second operation instructing portion 2i.

An HDD 12 is a mass-storage device that has recorded thereon the data transferred to the multi-function peripheral 10 and the received e-mail data; a RAM 13 is a random access memory that temporarily has various control data stored thereon, and a ROM 14 is a read only memory that has stored thereon the OSD data such as guidance information (operation guide information) described later.

A controlling portion 15 executes a process of displaying the OSD data such as guidance information recorded on the ROM 14 on the guide displaying portion 1a, the display panel 2a, etc., and a process of controlling the above functional blocks. Thick line B of FIG. 3 represents a data bus.

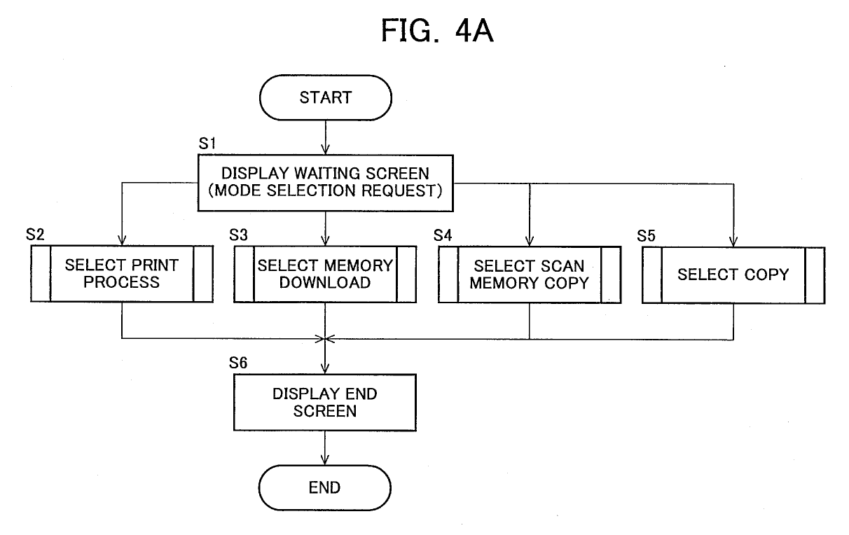

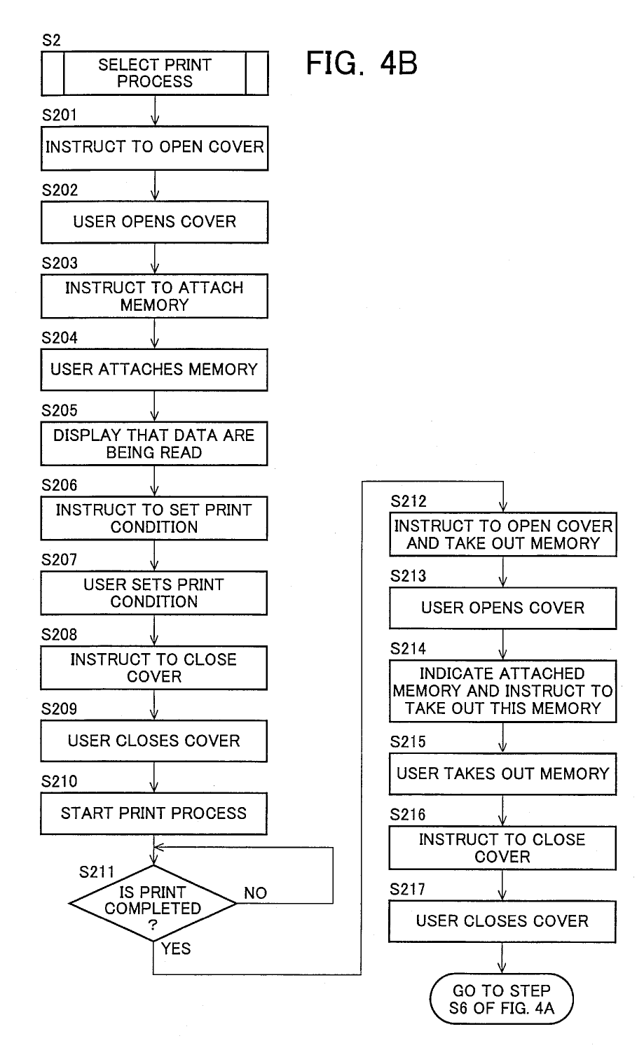

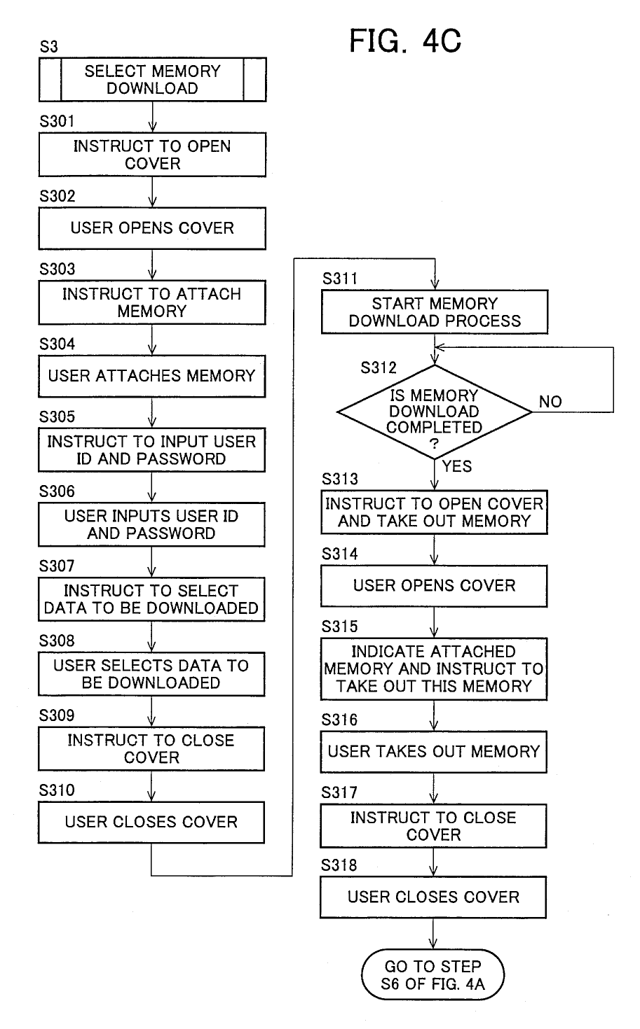

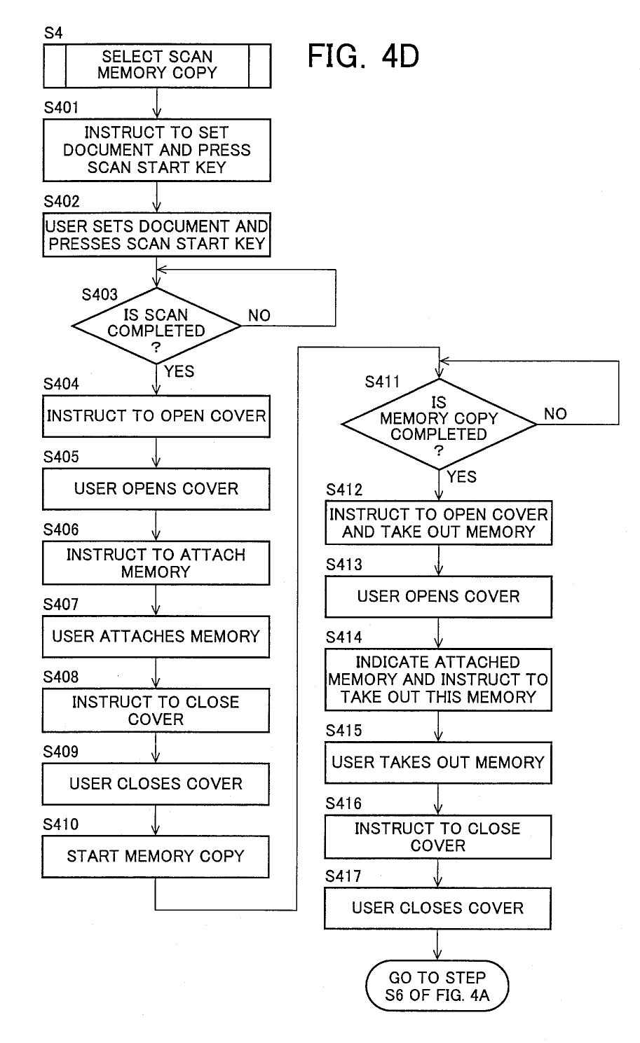

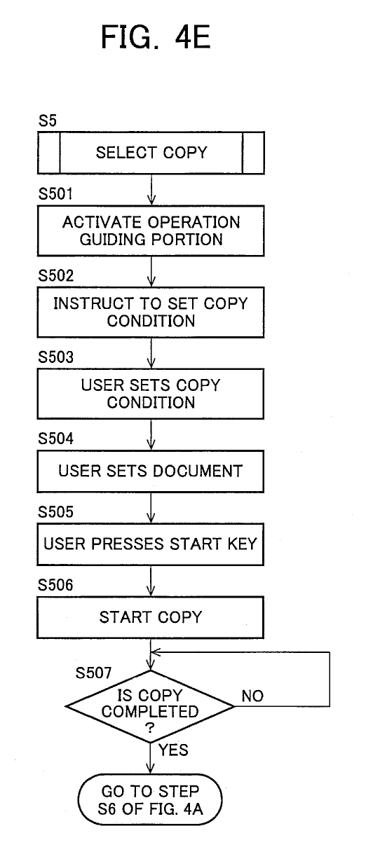

How a user operates the multi-function peripheral 10 will be described with reference to the drawings depicting situations of the first displaying device 10a included in the multi-function peripheral 10, the first operation instructing portion 1i included in the second displaying device 10d, and second operation instructing portion 2i shown in FIGS. 2A to 2H as well as flowcharts of processes executed when using various functions of the multi-function peripheral 10 shown in FIGS. 4A to 4E.

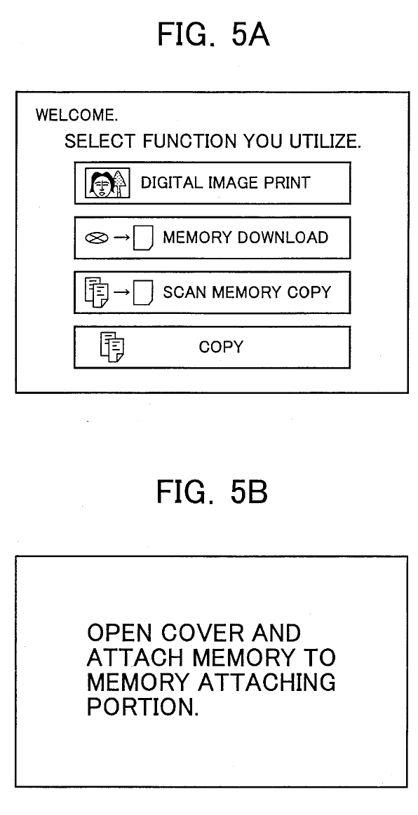

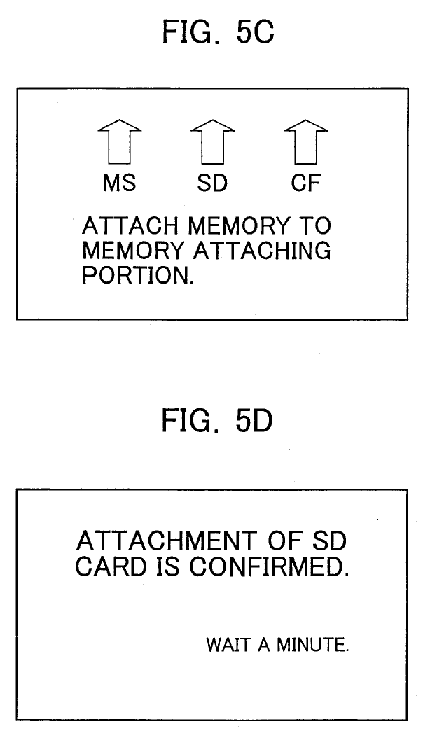

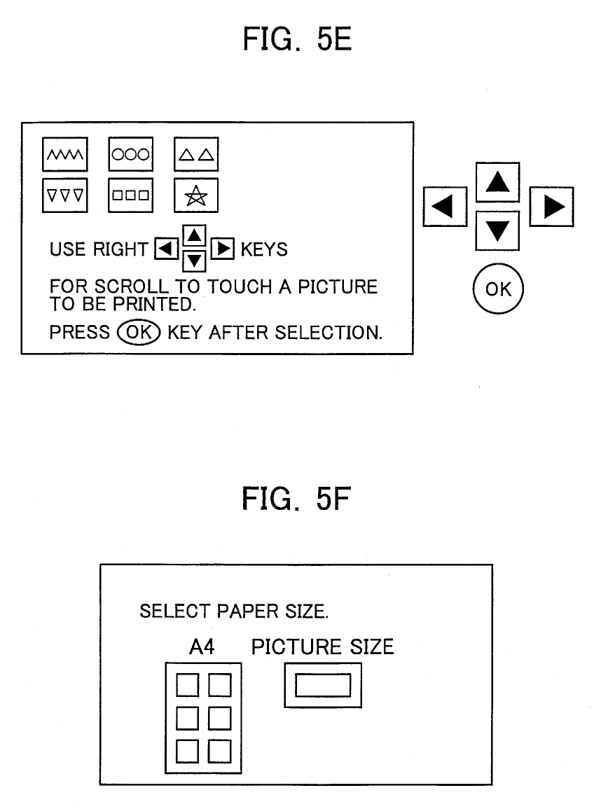

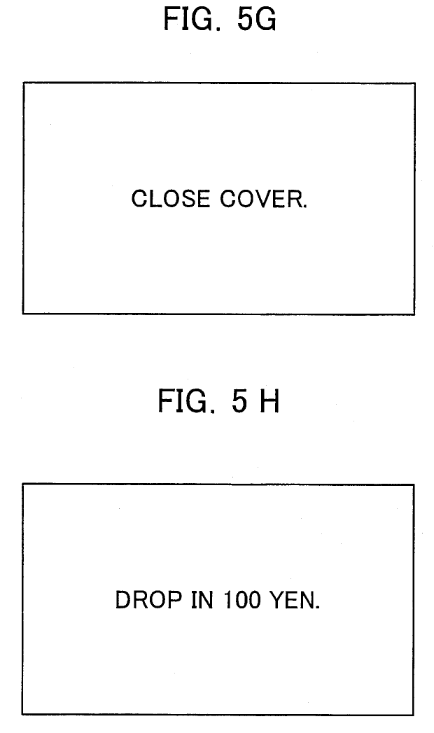

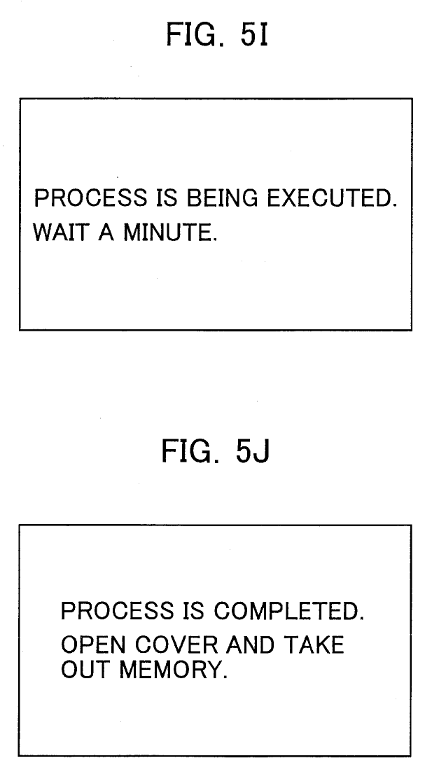

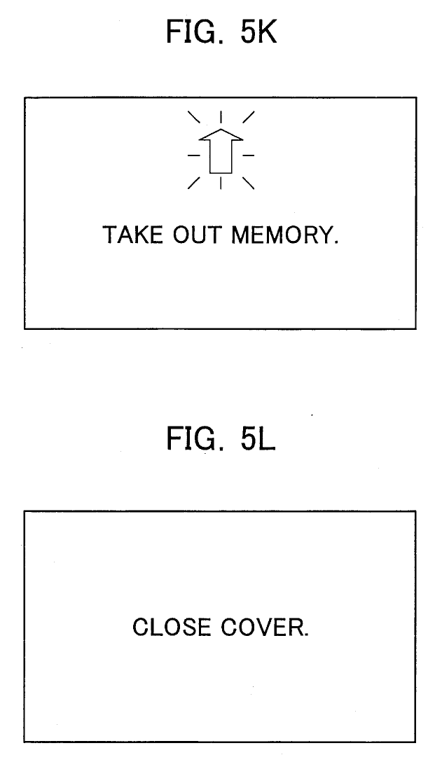

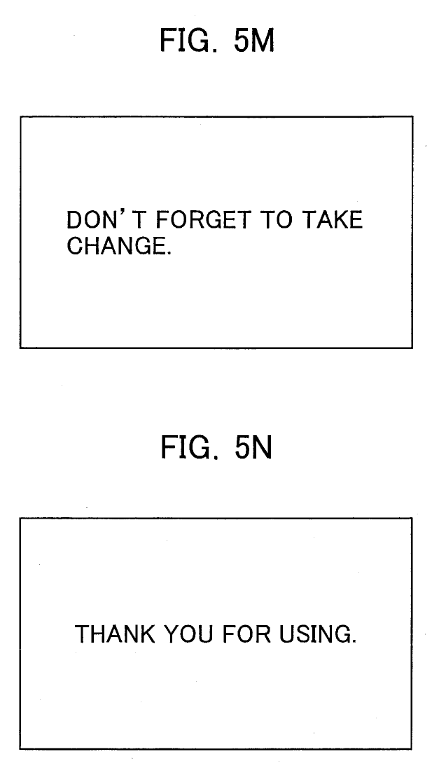

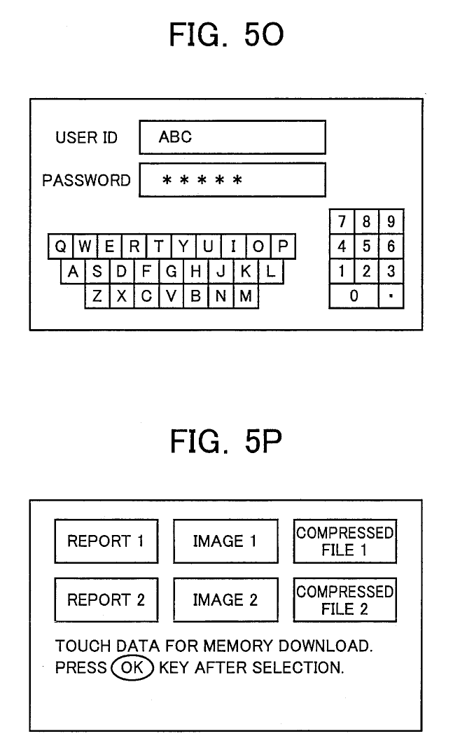

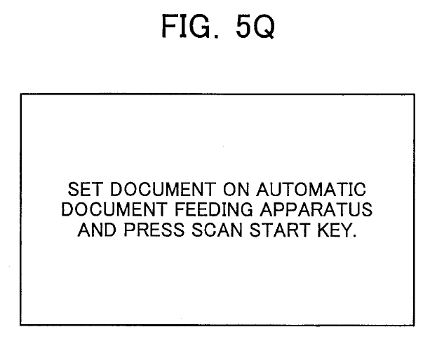

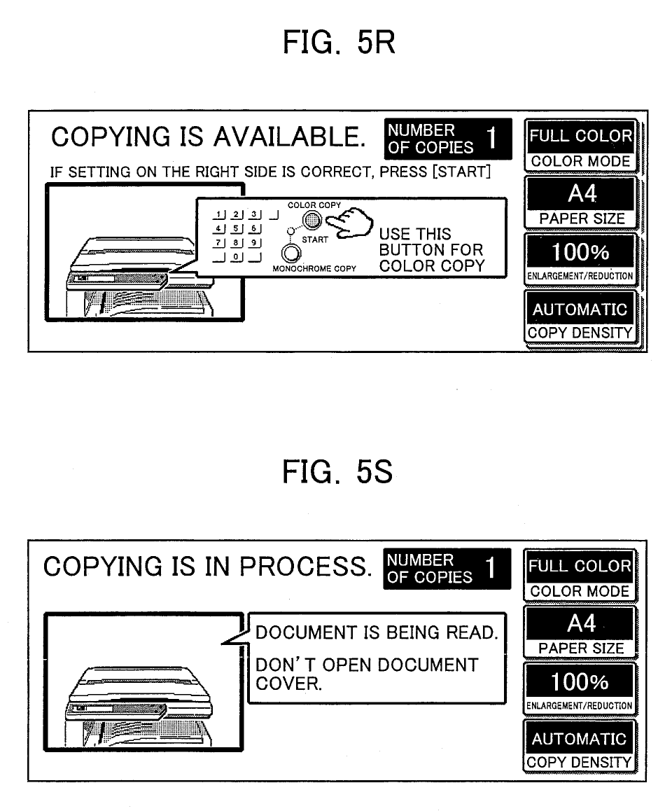

The guidance screens displayed on the first displaying portion 10a, the guide displaying portion 1a of the first operation instructing portion 1i, and the display panel 2a of the second operation instructing portion 2i will be described with reference to FIGS. 5A to 55.

FIG. 4A is a flowchart for explaining a process when a user selects various functions of the multi-function peripheral, and when a user approaches the multi-function peripheral 10, the guide displaying portion 1a (or the first displaying device 10a) displays a guidance screen (FIG. 5A) that requests the user to select a function of the multi-function peripheral 10 (step S1).

When the user selects any one of digital image print, memory download, scan memory copy, and copy from the guidance screen (FIG. 5A), the controlling portion 15 executes the process in accordance with the selection.

Digital Image Print:

A process of printing image data recorded on the memory card 20 with the multi-function peripheral 10 will be described with reference to the flowchart of FIG. 4B. FIG. 4B is a flowchart for explaining the guidance screen displayed at the time of the print process and the user operations. If the digital image print is selected from the guidance screen (FIG. 5A) displayed on the guide displaying portion 1a (or the first displaying device 10a) (step S2 of FIG. 4A: select print process), the controlling portion 15 displays on the guide displaying portion 1a (or the displaying device 10a) the guidance screen (FIG. 5B) giving an instruction to open the cover portion 3 and attach the memory card 20 to the memory card attaching portions 4a to 4c of the multi-function peripheral 10 (step S201).

When the user opens the cover portion 3 as shown in FIG. 2B (step S202), a cover open/close detecting portion 5 detects that the cover portion 3 is opened, and the controlling portion 15 turns on the display operation of the display panel 2a and displays on the display panel 2a the guidance screen (FIG. 5C) giving an instruction to attach the memory card 20 to the memory card attaching portions 4a to 4c (step S203). The display operation of the guide displaying portion 1a is terminated (turned off) at the same time. The operation of opening the cover portion 3 may be automated in conjunction with the selection of the process.

When the user attaches the memory card 20 to the memory card attaching portions 4a to 4c as shown in FIG. 2C (step S204), the memory card attachment detecting portion 4d detects that the memory card 20 is attached, and the controlling portion 15 displays on the display panel 2a the guidance screen (FIG. 5D) indicating that the attachment of the memory card 20 (SD) is confirmed and that a predetermined process is executed such as reading data recorded in the memory card 20, i.e., the status of the data process (step S205).

When the predetermined process is subsequently completed, the controlling portion 15 displays on the display panel 2a the guidance screen (FIG. 5E) giving an instruction to select image data to be printed from the image data recorded on the memory card 20 (step S206).

When the user utilizes the selection screen to select the image data to be printed as shown in FIG. 2D, the controlling portion 15 further displays on the display panel 2a the guidance screen (FIG. 5F) giving an instruction to select a paper size of the printing. The user selects a paper size while watching this selection screen (step S207). The input operation performed in accordance with the operation instructions displayed on the display panel 2a may be performed in any modes such as key input through the operation keys 2b or a touch-panel mode.

When the user completes the selection of the paper size, the controlling portion 15 displays on the display panel 2a the guidance screen (FIG. 5G) giving an instruction to close the cover portion 3 and the guidance screen (FIG. 5H) giving an instruction to drop a predetermined charge into a coin-operated vendor (not shown) (step S208).

When the user closes the cover portion 3 as shown in FIG. 2E (step S209), the cover open/close detecting portion 5 detects that the cover portion 3 is closed; the print portion 11a starts the print process of the selected image data (step S210); and the controlling portion 15 displays on the guide displaying portion 1a (or the displaying device 10a) the guidance screen (FIG. 5I) indicating that the printing is currently executed. The display operation of the display panel 2a is turned off at the same time as the cover portion 3 is closed. The cover portion 3 may automatically be closed after predetermined operation.

Since the memory card 20 is covered by the cover portion 3 while the image data recorded on the memory card 20 are transferred to the multi-function peripheral 10 as above, the user cannot take out the memory card 20. Therefore, the memory card 20 and the data recorded on the memory card 20 will not be destroyed by taking out the memory card 20 during the image data transfer. Since the display operation is terminated in the display panel 2a that has been displaying the screen at the same time as the cover portion 3 is closed, the power consumption is reduced (electric power is saved).

A locking device holding the cover portion 3 in the closed state may be provided and when the user attaches the memory card 20 and closes the cover portion 3, the guide displaying portion 1a may display the guidance screen prompting the locking device to be operated. The locking device may automatically be actuated to forcibly lock the cover portion 3. This eliminates the possibility of user accidentally opening the cover during the printing and taking out the attached memory card 20.

When the print process is completed (step S211: YES), the controlling portion 15 displays on the guide displaying portion 1a (or the displaying device 10a) the guidance screen (FIG. 5J) giving an instruction to open the cover portion 3 and take out the attached memory card 20 since the print process is completed (step S212).

When the user opens the cover portion 3 as shown in FIG. 2F (step S213), the cover open/close detecting portion 5 detects that the cover portion 3 is opened and the controlling portion 15 displays on the display panel 2a the guidance screen (FIG. 5K) indicating the attached memory card and giving an instruction to take out the memory card (step S214).

Since the guidance screen is displayed to give instructions to attach and detach the memory card 20 attached to the multi-function peripheral 10 in conjunction with the opening/closing of the cover portion 3 as above, the user can easily understand when the memory card 20 should be attached and detached, and the operationality is enhanced. This prevents the user from forgetting to take out the memory card.

When the user takes out the memory card 20 from the memory card attaching portions 4a to 4c as shown in FIG. 2G (step S215), the memory card attachment detecting portion 4d of the memory card attaching portions 4a to 4c detects that the memory card 20 is taken out, and the controlling unit 15 displays on the display panel 2a the guidance screen (FIG. 5L) giving the user an instruction to close the cover portion 3 (step S216).

Since the memory card attaching portions 4a to 4c are normally covered by the cover portion 3 and the memory card attaching portions 4a to 4c are exposed to the outside only when the memory card 20 is attached and detached as above, this can eliminate as much as possible the possibility that dusts and foreign matters enter into the memory reader of the memory card attaching portions 4a to 4c and adversely affect the performance of the memory reader.

When the user closes the cover portion 3 as shown in FIG. 2H (step S217), the cover open/close detecting portion 5 detects that the cover portion 3 is closed and the controlling portion 15 displays on the guide displaying portion 1a (or the displaying device 10a) the guidance screen (FIGS. 5M and 5N) indicating that the entire course of the print process is terminated (step S6 of FIG. 4A).

If the cover portion 3 is closed with the memory card 20 forgotten to be taken out, the display can be made to indicate that the memory card 20 is forgotten to be taken out, and a notification sound may also be output. Although the case of printing the image data has been described for the print process, data created with various applications such as word processor and spreadsheet applications can be printed in addition to the image data.

Although the operation keys 1b are not disposed on the upper surface of the cover portion 3 in FIG. 2H, this means that operation keys disposed on the data processing apparatus 10 may be used for the operation keys 1b. The guide displaying portion 1a may also be omitted by using the displaying device 10a disposed on the data processing apparatus 10. Conversely, the displaying device and the operation keys disposed on the data processing apparatus 10 may be omitted to perform the operations with the guide displaying portion 1a and the operation keys 1b on the cover portion 3.

Memory Download:

In the memory download, the multi-function peripheral 10 connected to the internet is functioned as a file server, and if a user transfers data to the multi-function peripheral 10 and the user authentication succeeds through password input, etc., after the transfer, the transferred data (recorded in the HDD 12) is downloaded onto the memory card 20 attached to the multi-function peripheral 10. The memory download will be described with reference to the flowchart for explaining the guidance screen displayed at the time of the memory download and the user operations shown in FIG. 4C. The memory card attaching portions 4a to 4c serve as data input portions that input data recorded in the memory card into the data processing apparatus and also as data output portions that output data in the data processing apparatus onto a memory card. It is assumed in this description that a user has already transferred data to the multi-function peripheral 10.

If a user selects the memory download from the guidance screen (FIG. 5A) (step S3 of FIG. 4A: select memory download), the user attaches the memory card 20 to the multi-function peripheral 10 as described in FIG. 4B (steps S301 to S304: corresponding to steps S201 to S204 of FIG. 4B). The controlling portion 15 displays an input screen for user ID and password (FIG. 5O) on the display panel 2a to instruct the user to input the user ID and the password (step S305).

When the user ID and the password are input as shown in FIG. 2D (step S306) and the password authentication succeeds, the guidance screen (FIG. 5P) is displayed on the display panel 2a to instruct the user to select the data for the memory download (step S307). The user selects the data for the memory download while watching this selection screen (step S308).

When the user completes the selection of the data for the memory download, the controlling portion 15 displays on the display panel 2a the guidance screen (FIG. 5G) giving an instruction to close the cover portion 3 and the guidance screen (FIG. 5H) giving an instruction to drop a predetermined charge into the coin-operated vendor (not shown) (step S309).

When the user closes the cover portion 3 (step S310), the memory download portion 11c starts a process of downloading the selected data onto the memory card 20 (step S311) and after the completion (step S312: YES), the user takes out the attached memory card 20 and closes the cover portion 3 in accordance with the guidance screen as above (steps S313 to S318: corresponding to steps S212 to S217 of FIG. 4B).

Scan Memory Copy:

A process of copying the read (scanned) document as image data, etc., onto the memory will be described with reference to FIG. 4D. FIG. 4D is a flowchart for explaining the guidance screen displayed at the time of the scan memory copy and the user operations. If the scan memory copy is selected from the guidance screen (FIG. 5A) (step S4 of FIG. 4A: select scan memory copy), the controlling portion 15 displays on the guide displaying portion 1a the guidance screen (FIG. 5Q) giving an instruction to set a document to be scanned on the automatic document feeding apparatus 10b and press a scan start key (step S401).

When the user sets the document on the automatic document feeding apparatus 10b and presses the scan start key (step S402), the scan portion 11b starts the scan process and sequentially and temporarily records the scanned document data onto the HDD 12 or the ROM 14. When the scan process is completed (step S403: YES), the user opens the cover portion 3, attaches the memory card 20 to the multi-function peripheral 10, and closes the cover portion 3 (steps S404 to S409: corresponding to steps S201 to S204, S208, and S209 of FIG. 4B). The openable/closable document holder 10c may be opened to set the document and the set document may be scanned.

When the user closes the cover portion 3 (step S409), the scan memory copy portion 11d starts a process of copying the data temporarily recorded on the HDD 12 or the ROM 14 onto the memory card 20 (step S410), and when the memory copy process is completed (step S411: YES), the user takes out the attached memory card 20 and closes the cover portion 3 in accordance with the guidance screen as above (steps S412 to S417: corresponding to steps S212 to S217 of FIG. 4B). The memory card 20 may be attached before the scan operations for reading the document, and after the cover portion 3 is closed, a series of the scan operations may be performed.

Copy:

Lastly, an example of the guidance screen and the user operations in the case of copying using the first data input portion 6 will be described with reference to the flowchart of FIG. 4E. If a user selects the copy from the guidance screen (FIG. 5A) displayed on a selection screen displaying portion 10a or the guide displaying portion 1a (step S5 of FIG. 4A: select copy), the controlling portion 15 operates the guide displaying portion 1a (or the displaying device 10a) (step S501) to display on the guide displaying portion 1a (or the displaying device 10a) the guidance screen (FIG. 5R) for starting the copy, which gives an instruction to set the copy conditions (such as the number of copies and the enlargement/reduction rate) (step S502).

When the user operates a copy condition setting key (setting the number of copies, etc.) among the first operation keys 1b of the first operation instructing portion 1i to set the copy conditions in accordance with the guidance screen (step S503), the scanner (first data input portion 6) becomes operable. The user sets a document on the automatic document feeding apparatus 10b (step S504) and presses the first operation key 1b (start key) (step S505).

The scanner (first data input portion 6) starts operating to input the document data through the scanner to the copy portion 11e of the data processing portion 10, and the copy portion 11e copies the document data read by the scanner (step S506). The controlling portion 15 displays the guidance screen (FIG. 5S) indicating that the copying is performed.

When the copying is completed (step S507: YES), the controlling portion 15 displays the guidance screen (FIG. 5R) for starting the copy again on the guide displaying portion 1a (or the displaying device 10a).

Only when the cover portion 3 is in the closed state, the input operation from the first operation instructing portion 1i (the first operation keys 1b) is performed as above, and when the data are input from the scanner (the first data input portion 6), the copy portion 11e of the data processing portion 10 executes the process corresponding to the input operation (the set copy conditions). Therefore, when using the copy function, which is a common function of the multi-function peripheral 10, the user can correctly perform the operations and the convenience is enhanced.

When the guidance screen (FIG. 5A) is displayed on the guide displaying portion 1a (step S1 of FIG. 4A) to request the user to select the functions of the multi-function peripheral (select to operate either the first data input portion or the second data input/output portion), if the user opens the cover portion 3, the memory card attaching portions 4a to 4c may be made operable as if a selection is automatically made to execute the data process utilizing the second data input portion 4 (memory card).

That is, if the cover portion 3 is opened, a selection screen is displayed on the display panel 2a to select the data process utilizing the second data input portion, i.e., the print process, the memory download, the scan memory copy, or the copy.

In this case, the most frequently used process may automatically be selected from the print process, the memory download, the scan memory copy, and the copy. This can enhance the convenience and operationality for the user.

Similarly, when the guidance screen (FIG. 5A) is displayed, if the operation keys 1b (such as the copy condition setting key) of the first operation instructing portion 1i are operated, the subsequent operation guide may be displayed as if the copy function is selected.

Although the opening/closing mechanism of the cover portion 3 is exemplary represented by opening/closing of the hinge mechanism in this embodiment, a slidable cover portion may be used and various opening/closing mechanisms may be employed.

Although the memory card 20 is attached to the memory card attaching portions 4a to 4c, the present invention is applicable to non-contact memories.

As repeatedly described, the selection screen displaying portion 10a may be integrated with the guide displaying portion 1a disposed on the upper surface of the cover portion 3.

The present invention can prevent a memory card and data in the memory card from being destroyed due to taking out the memory card during data access.

A memory card can mechanically be restricted from being attached/detached in conjunction with a series of user operations and a guidance screen is displayed in conjunction with a series of user operations to enhance the convenience of the user.

1. A data processing apparatus comprising:
a recording medium attaching portion that can have a recording medium detachably attached;
an attachment detecting portion that detects whether a recording medium is attached to the recording medium attaching portion;
an operation instructing portion that gives instructions to prompt operations for a data process related to the recording medium and accepts user operations;
a data processing portion that executes a data process in accordance with the input operation from the operation instructing portion; and
a cover portion that is freely opened and closed to cover the recording medium attaching portion,
only when the cover portion is in the opened state, the data processing apparatus allowing a recording medium to be attached/detached to/from the recording medium attaching portion and the input operation from the operation instructing portion, when the attachment detecting portion detects that the recording medium is attached and the cover portion is put into the closed state, the data processing portion executing a data process in accordance with the input operation.

2. The data processing apparatus as defined in claim 1, wherein the cover portion covers the recording medium attaching portion and the operation instructing portion.

3. The data processing apparatus as defined in claim 1, comprising a guide displaying portion that displays operation guide information of the data processing apparatus on the upper side of the cover portion or in the vicinity of the cover portion.

4. The data processing apparatus as defined in claim 3, comprising a locking device that holds the cover portion in the closed state, wherein the guide displaying portion displays the operation guide information prompting the locking device to be operated.

5. The data processing apparatus as defined in claim 3, wherein the guide displaying portion displays the status of the data process of the data processing apparatus.

6. The data processing apparatus as defined in claim 3, wherein the guide displaying portion displays the operation guide information related to opening of the cover portion, taking out of the recording medium, etc., in conjunction with the completion of the data process of the data processing apparatus.

7. The data processing apparatus as defined in claim 3, wherein the guide displaying portion displays information indicating whether the recording medium is attached to the recording medium attaching portion.

8. A data processing apparatus comprising:
a first operation instructing portion that includes an operating portion accepting user operations for a data process related to input data of a first data input portion;
a second operation instructing portion that gives instructions to prompt operations for a data process related to input data of a second data input portion and accepts user operations;
a data processing portion that executes a data process in accordance with the input operation from the first operation instructing portion or the second operation instructing portion; and
a cover portion that is freely opened and closed to cover the second data input portion,
the first operation instructing portion being disposed on the upper surface of the cover portion, only when the cover portion is in the opened state, the data processing apparatus allowing the input operation from the second operation instructing portion.

9. The data processing apparatus as defined in claim 8, wherein the second data input portion is a recording medium attaching/detaching portion and wherein only when the cover portion is in the opened state, a recording medium can be attached/detached to/from the recording medium attaching/detaching portion.

10. The data processing apparatus as defined in claim 8, wherein the cover portion covers the second data input portion and the second operation instructing portion.

11. The data processing apparatus as defined in claim 8, wherein the first data input portion do not operate when the cover portion is in the opened state.

12. The data processing apparatus as defined in claim 8, wherein when the cover portion is in the closed state, if the input operation from the first operation instructing portion is performed and data are input from the first data input portion, the data processing portion executes a data process corresponding to the input operation from the first operation instructing portion.

13. The data processing apparatus as defined in claim 8, wherein when the cover portion is in the opened state, if the input operation from the second operation instructing portion is performed and the cover portion is closed, the data processing portion executes a data process corresponding to the input operation from the second operation instructing portion.

14. The data processing apparatus as defined in claim 8, comprising a guide displaying portion that displays operation guide information, wherein the guide displaying portion displays a selection screen for selecting a data process using either the first data input portion or the second data input portion.

15. The data processing apparatus as defined in claim 14, wherein if the cover portion is opened while the guide displaying portion displays the selection screen, the second data input portion is made operable as a selection is made to operate the second data input portion.

16. The data processing apparatus as defined in claim 8, wherein the second data input portion also is a data output portion.
